(19) United States
(12) Patent Application Publication
(10) Pub. No.: US 2023/0122648 A1
(43) Pub. Date: Apr. 20, 2023

(54) TRIP INFORMATION REPORTING DEVICE, TRIP INFORMATION REPORTING METHOD, AND NON-TRANSITORY MEMORY MEDIUM MEMORIZING PROGRAM

(71) Applicant: TOYOTA JIDOSHA KABUSHIKI KAISHA, Toyota-shi (JP)

(72) Inventors: Junichiro TAMAO, Nagoya-shi (JP); Hiroaki NAGASE, Fujisawa-shi (JP); Hirotaka NAKAYAMA, Toyota-shi (JP); Akihiro MOTODA, Toyota-shi (JP); Ryo MIZUNO, Miyoshi-shi (JP)

(73) Assignee: TOYOTA JIDOSHA KABUSHIKI KAISHA, Toyota-shi (JP)

(21) Appl. No.: 17/940,478

(22) Filed: Sep. 8, 2022

(30) Foreign Application Priority Data
Oct. 20, 2021 (JP) 2021-171827

(51) Int. Cl. G06Q 30/02; G06Q 30/06

(52) U.S. Cl. CPC G06Q 30/0283; G06Q 30/0645; G06Q 30/0207

(57) ABSTRACT

A trip information reporting device including a processor, the processor being configured to: acquire a trip cost including a car rental cost from a plurality of regions, the car rental cost being established on the basis of information relating to rental car availability; and report the trip costs from the plurality of regions to a user.

### CROSS-REFERENCE TO RELATED APPLICATION

This application is based on and claims priority under 35 USC 119 from Japanese Patent Application No. 2021-171827 filed on Oct. 20, 2021, the disclosure of which is incorporated by reference herein.

### BACKGROUND

### Technical Field

The present disclosure relates to a trip information reporting device, a trip information reporting method, and a non-transitory memory medium memorizing a program.

### Related Art

Japanese Patent Application Laid-Open (JP-A) No. 2017-084358 discloses a multipurpose trip planning method for a consumer (a user) to make a trip plan with an itinerary including multiple destinations. More specifically, in JP-A No. 2017-084358, a user enters a destination area and trip start date, a user interface displays a map of the destination area and a calendar, and the user may enter details of destinations and periods of stay.

However, in the trip planning method of JP-A No. 2017-084358, it is assumed that the user has decided on a trip destination. Therefore, there is scope for improvement for a user who has not decided on a trip destination to plan a trip on a low budget.

### SUMMARY

The present disclosure provides a trip information reporting device, a trip information reporting method, and a non-transitory memory medium storing a program that may plan a trip on a low budget with which a user who has not decided on a trip destination.

A first aspect of the present disclosure is a trip information reporting device including: a processor, the processor being configured to: acquire a trip cost including a car rental cost from a plurality of regions, the car rental cost being established on the basis of information relating to rental car availability; and report the trip costs from the plurality of regions to a user.

In the trip information reporting device according to the first aspect, trip cost including a car rental cost is acquired from plural regions and reported to the user. Therefore, the user may understand the trip cost including a car rental cost, and may decide on a trip destination without concern about expenses required for transport at the trip destination. Because the car rental costs are established on the basis of information relating to vehicles available for car rental, a user may select a region with cheap car rental costs and may take a trip on a low budget.

In a second aspect of the present disclosure, in the first aspect, the car rental cost may be established for respective car rental offices, such that the higher a rental car availability rate is, the lower the car rental cost is.

In the trip information reporting device according to the second aspect, car rental costs are established for respective the car rental offices such that the rental cost is lower where the availability rate of rental cars is higher. Therefore, trip costs that are discounted relative to standard costs in regions with relatively low popularity may be reported to the user.

In a third aspect of the present disclosure, in the first aspect or the second aspect, together with the trip cost, the processor may report a discount amount or discount rate applied to a standard rate for car rental.

In the trip information reporting device according to the third aspect, discount amounts or discount rates applicable to car rental costs are calculated from standard costs that do not take account of rental car availability rates. Therefore, the user may understand levels of discounts.

In a fourth aspect of the present disclosure, in any one of the first to third aspects, as the trip cost, the processor may report to the user an amount including a fuel cost of a rental car.

In the trip information reporting device according to the fourth aspect, because fuel costs of rental cars are included in the trip costs, the user may use a rental car at a trip destination without worrying about fuel costs.

In a fifth aspect of the present disclosure, in any one of the first to fourth aspects, the processor reports to the user information relating to a travel route in a vicinity of a trip destination.

In the trip information reporting device according to the fifth aspect, the user receives information relating to a travel routes in vicinities of the trip destinations, and the user may select a trip destination in accordance with their driving technique. For example, it may be reported to the user that there are many narrow roads in a particular region, and a user with little experience of driving may exclude that region from the trip destinations.

In a sixth aspect of the present disclosure, in any one of the first to fifth aspects, as the trip cost, the processor reports to the user an amount including an accommodation fee at a trip destination and a facility usage fee in a vicinity of the trip destination.

In the trip information reporting device according to the sixth aspect, because the trip costs include facility usage fees, the user may minimize costs to be paid at a trip destination, and the user may more easily understand a total amount required for the trip.

A seventh aspect of the present disclosure is a trip information reporting method including: acquiring a trip cost including a car rental cost from a plurality of regions, the car rental cost being established on the basis of information relating to rental car availability; and reporting the trip costs from the plurality of regions to a user.

An eighth aspect of the present disclosure is a non-transitory storage medium storing a program executable by a computer to perform processing, the processing including: acquiring a trip cost including a car rental cost from a plurality of regions, the car rental cost being established on the basis of information relating to rental car availability; and reporting the trip costs from the plurality of regions to a user.

As described above, according to the trip information reporting device, trip information reporting method, and non-transitory memory medium memorizing a program according to the present disclosure, a user who has not decided on a trip destination may plan a trip on a low budget.

### BRIEF DESCRIPTION OF THE DRAWINGS

An exemplary embodiment of the present disclosure will be described in detail based on the following figures, wherein:

FIG. 1 is a schematic diagram of a system including a trip information reporting device according to an exemplary embodiment;

FIG. 2 is a block diagram illustrating hardware structures of the trip information reporting device according to the exemplary embodiment;

FIG. 3 is a block diagram illustrating functional structures of the trip information reporting device according to the exemplary embodiment;

FIG. 4 is an example of a screen display that is displayed at a portable terminal by the trip information reporting device according to the exemplary embodiment; and

FIG. 5 is a flowchart illustrating an example of a flow of trip information reporting processing according to the exemplary embodiment.

### DETAILED DESCRIPTION

A trip information reporting device 10 according to an exemplary embodiment is described with reference to the drawings.

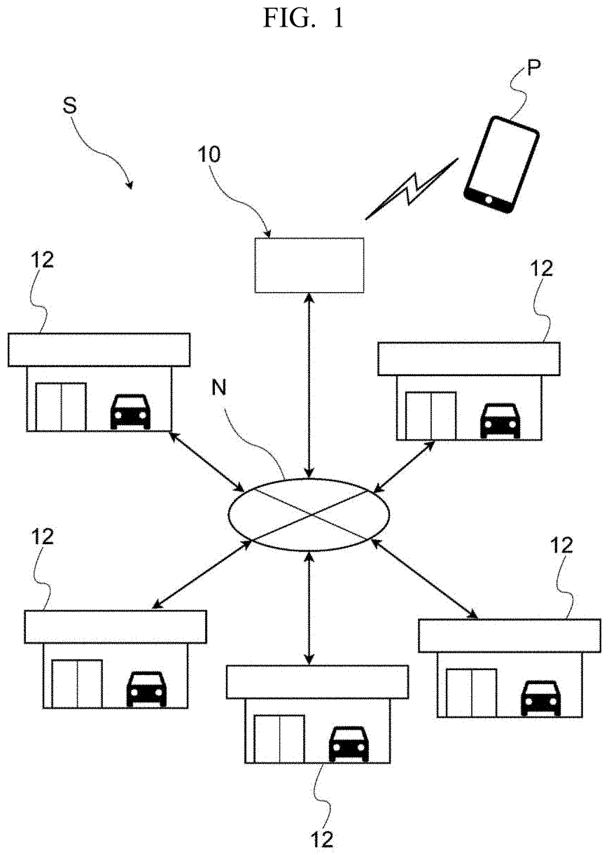

FIG. 1 illustrates a system S including the trip information reporting device 10. As illustrated in FIG. 1, the trip information reporting device 10 is capable of communications with plural car rental offices 12 via a network N. The trip information reporting device 10 is also configured to be capable of communications with a portable terminal P.

The car rental offices 12 are respective car rental offices located in predetermined regions that are specified as trip destinations. Each car rental office 12 holds plural vehicles to be rented out. The meaning of the term “car rental office 12” as used herein is intended to broadly include business establishments that hold vehicles for sharing among members of particular associations.

Vehicle rental costs are established for respective the car rental offices 12. Vehicle rental costs vary with regions, vehicle types and the like. Standard rental costs are specified at the respective car rental offices 12.

The car rental offices 12 each hold trip information such as costs relating to nearby trip destinations. The trip information may also be information acquired from travel agencies.

The trip information reporting device 10 according to the present exemplary embodiment acquires trip costs including car rental costs specified at the respective car rental offices 12 and reports the trip costs to a user.

### Hardware Structures of the Trip Information Reporting Device 10

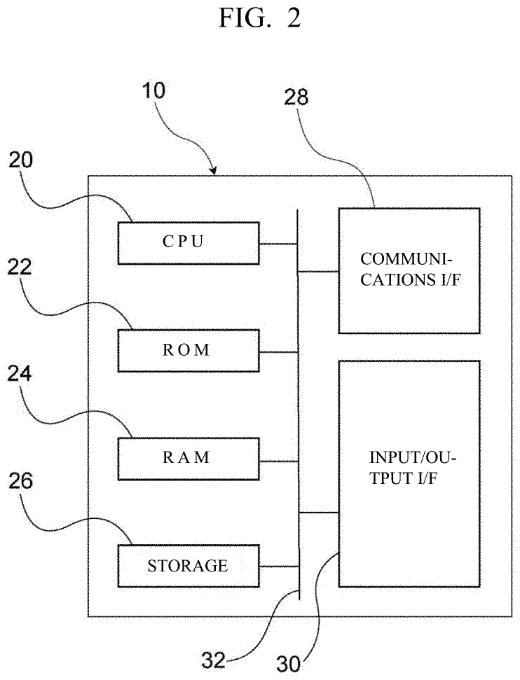

FIG. 2 is a block diagram illustrating hardware structures of the trip information reporting device 10. As illustrated in FIG. 2, the trip information reporting device 10 includes a central processing unit (CPU, or processor) 20, read-only memory (ROM) 22, random access memory (RAM) 24, storage 26, a communications interface (communications I/F) 28, and an input/output interface (input/output I/F) 30. These structures are connected to be capable of communicating with one another via a bus 32.

The CPU 20 is a central arithmetic processing unit that executes various programs and controls respective parts. That is, the CPU 20 reads a program from the ROM 22 or the storage 26, and executes the program using the RAM 24 as a workspace. The CPU 20 performs control of the structures described above and various kinds of computational processing in accordance with the program recorded in the ROM 22 or storage 26.

The ROM 22 stores various programs and various kinds of data. The RAM 24 serves as a workspace, temporarily memorizing programs and data. The storage 26 is constituted by a hard disk drive (HDD) or solid state drive (SSD). The storage 26 stores various programs, including an operating system, and various kinds of data. In the present exemplary embodiment, the ROM 22 or the storage 26 stores a program for performing trip information reporting processing, and various kinds of data and the like.

The communications interface 28 is an interface for the trip information reporting device 10 to communicate with an external server and other equipment, using a standard such as, for example, Controller Area Network (CAN), Ethernet (registered trademark), Long Term Evolution (LTE), Fiber Distributed Data Interface (FDDI), Wi-Fi (registered trademark) or the like.

The input/output interface 30 is an interface that is electronically connected with peripherals of the trip information reporting device 10. For example, the input/output interface 30 may be connected to a display for displaying information, a keyboard for entering information into the trip information reporting device 10, and so forth.

### Functional Structures of the Trip Information Reporting Device 10

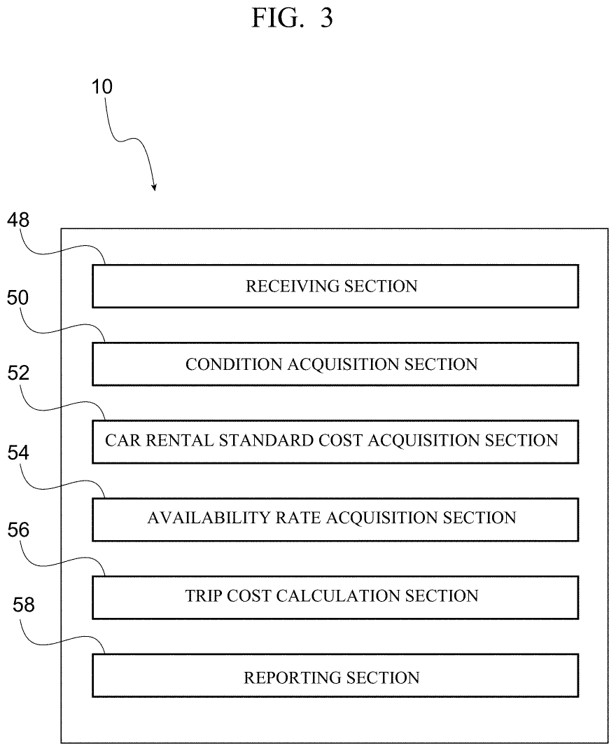

The trip information reporting device 10 uses the hardware resources described above to realize various functions. The functional structures realized by the trip information reporting device 10 are described with reference to FIG. 3.

As illustrated in FIG. 3, the trip information reporting device 10 is configured to include, as functional structures, a receiving section 48, a condition acquisition section 50, a car rental standard cost acquisition section 52, an availability rate acquisition section 54, a trip cost calculation section 56 and a reporting section 58. These functional structures are realized by the CPU 20 reading and executing the program memorized at the ROM 22 or storage 26.

The receiving section 48 receives trip cost report instructions from a user. As an example in the present exemplary embodiment, the receiving section 48 receives report instructions from the user via the portable terminal P. For example, the receiving section 48 may receive trip cost report commands from an application at the portable terminal P.

The condition acquisition section 50 acquires search conditions specified by the user. These search conditions include, for example, distance from an arbitrary location such as the user's home or the like, a range of trip costs, a trip destination region and so forth. Thus, if the user uses the portable terminal P to specify at most 300 km from home as a condition, the condition acquisition section 50 acquires this condition as a search condition.

The car rental standard cost acquisition section 52 acquires standard costs for car rentals specified by the respective car rental offices 12. Standard costs may be acquired only from the car rental offices 12 that satisfy the conditions specified by the user. A database recording respective standard costs for all of the car rental offices 12 being overseen may be memorized at a server, which is not illustrated in the drawings, or the like. In this situation, the car rental standard cost acquisition section 52 may acquire the standard costs of car rentals by acquiring this database from the server.

The availability rate acquisition section 54 acquires current availability rates at the respective car rental offices 12. For example, the availability rate acquisition section 54 may acquire availability rates of the respective car rental offices 12 by consulting a database in which availability rates of all of the car rental offices 12 being overseen are recorded. In this situation, the car rental offices 12 may periodically access this database and update the availability rates.

The trip cost calculation section 56 calculates a trip cost including a car rental cost for respective the car rental offices 12, such that the higher the availability rate of rental cars, the lower the cost. That is, the trip cost calculation section 56 calculates a car rental cost for each car rental office 12 in which a standard fee set at the car rental office 12 is multiplied with a coefficient set on the basis of the availability rate, and the trip cost calculation section 56 calculates a trip cost in which this car rental cost is added.

For example, when 70% of of the rental cars held by the car rental office 12 are rented out, the availability rate for that car rental office 12 is 30%. If the coefficient is set to 1 when the availability rate is 30%, then when the availability rate is 30%, the car rental cost is the same as the standard cost. Car rental costs do not go above the standard cost in the present exemplary embodiment. Thus, when the availability rate is 30% or less, such as when the availability rate is 20%, the car rental cost is at the standard cost.

On the other hand, when the availability rate is higher than 30%, the coefficient decreases as the availability rate increases. For example, if the coefficient is set to 0.5 when the availability rate is 70%, the car rental cost is at half the standard cost. As an example, the trip cost calculation section 56 according to the present exemplary embodiment reduces the coefficient in steps as the rental car availability rate increases.

The trip cost calculation section 56 according to the present exemplary embodiment calculates an amount of money including a fuel cost of a rental car as a trip cost. More specifically, the fuel cost is specified from an average car rental running distance calculated on the basis of information of a trip destination and a period of stay, and this fuel cost is added to the trip cost. The meaning of the term “fuel cost” as used herein is not intended to be limited to gasoline costs and the like. In the case of an electric vehicle using an electric motor as a drive source, an electric charging cost is used as the fuel cost, and in the case of a fuel cell vehicle, a filling cost of a fuel such as hydrogen or the like is used as the fuel cost.

The meaning of the term “trip cost” as used herein is not limited to costs combining a transport system usage fee for a return trip to the trip destination with car rental costs but may also include facility usage fees. When the trip is for two days or more, accommodation costs can be included in the trip cost.

The trip cost calculation section 56 according to the present exemplary embodiment calculates an amount including an accommodation fee at the trip destination and facility usage fees in the vicinity of the trip destination as the trip cost. The meaning of the term “facility usage fees” as used herein is not intended to be limited to charges for admission to facilities such as galleries, aquariums, zoos and so forth but also to include food and drink costs at restaurants, discount coupons covering portions of shopping costs in stores, and so forth.

The reporting section 58 reports trip costs for plural regions to the user. Specifically, the reporting section 58 reports only information satisfying the search conditions specified by the user. As an example in the present exemplary embodiment, the reporting section 58 transmits information to the portable terminal P, which is carried by the user, and the information is displayed at a display screen of the portable terminal P.

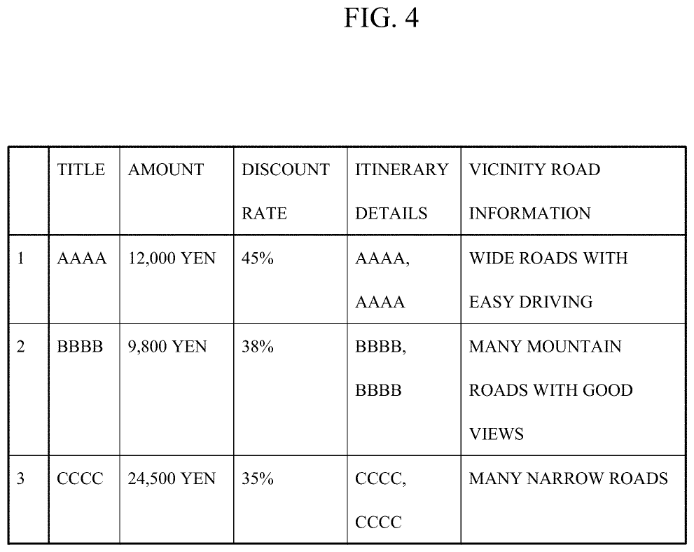

FIG. 4 illustrates an example of information displayed at the display screen of the portable terminal P. As illustrated in FIG. 4, the reporting section 58 causes information including titles, amounts, discount rates, itinerary details, and vicinity road information to be displayed at the portable terminal P.

The title field lists details that enable understanding of an overview of the trip. For example, details including a place name of the trip destination, a facility name or the like may be displayed as a title. The amount field lists a discounted cost calculated by the trip cost calculation section 56. The discount rate field lists a discount rate applied to the standard cost of car rental. That is, the reporting section 58 according to the present exemplary embodiment reports the discount rate applied to the standard cost of car rental together with the trip cost. Instead of the discount rate, the reporting section 58 may report a discount amount that is deducted from the standard cost.

The itinerary details field lists detailed information of the trip. The vicinity road information field lists information relating to a travel routes in the vicinity of the trip destination. For example, the reporting section 58 may illustrate that there are many wide roads. The reporting section 58 may also illustrate information about mountain roads with good views and so forth.

### Operation

Now, operation of the present exemplary embodiment is described.

### Example of Trip Information Reporting Processing

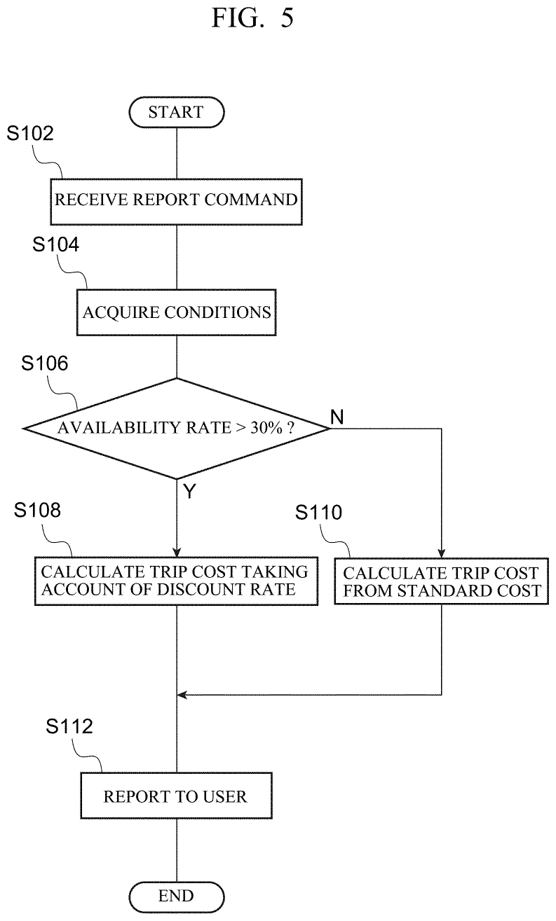

An example of trip information reporting processing at the trip information reporting device 10 according to the present exemplary embodiment is described using the flowchart illustrated in FIG. 5. This trip information reporting processing is executed by the CPU 20 reading a program from the ROM 22 or the storage 26 and loading the program into the RAM 24.

In step S102, the CPU 20 receives a trip cost report command. More specifically, by the functioning of the receiving section 48, the CPU 20 receives a trip cost report instruction from a user via the portable terminal P.

In step S104, the CPU 20 acquires conditions. More specifically, by the functioning of the condition acquisition section 50, the CPU 20 acquires search conditions specified by the user. The user gives the trip cost report instruction in a state in which the conditions have already been set. Therefore, the condition acquisition section 50 acquires conditions that are received together with the report command.

In step S106, the CPU 20 makes a determination as to whether an availability rate is greater than 30%. More specifically, the CPU 20 acquires a current availability rate from a database for respective the car rental offices 12 that satisfy the conditions assigned by the user. When the availability rate is 30% or less, the result of the determination in step S106 is negative and the CPU 20 proceeds to step S110.

Alternatively, when the availability rate of that car rental office 12 in step S106 is greater than 30%, the result of the determination in step S106 is affirmative and the CPU 20 proceeds to step S108.

In step S108, the CPU 20 calculates a trip cost taking into consideration a discount rate corresponding to the availability rate. More specifically, by the functioning of the trip cost calculation section 56, the CPU 20 calculates the trip cost including a discounted car rental cost. That is, by the functioning of the trip cost calculation section 56, the CPU 20 calculates the car rental cost by multiplying a standard cost of car rental with a coefficient corresponding to the availability rate. Further, by the functioning of the trip cost calculation section 56, the CPU 20 adds the calculated car rental cost to trip costs at a trip destination in the vicinity of the car rental office 12 to serve as the trip cost.

When the result of the determination in step S106 is negative, in step S110 the CPU 20 calculates the trip cost using the standard cost as the car rental cost.

In step S112, the CPU 20 reports the trip cost and so forth to the user. More specifically, by the functioning of the reporting section 58, the CPU 20 causes the trip cost to be displayed at the display screen of the portable terminal P carried by the user. At this time, by the functioning of the reporting section 58, the CPU 20 causes a discount rate, itinerary details, vicinity road information and the like to be displayed in addition to the trip cost. Then, the CPU 20 ends the trip information reporting processing.

As described above, in the trip information reporting device 10 according to the present exemplary embodiment, trip costs including car rental costs are acquired from plural regions and reported to a user. The car rental costs are established for respective car rental offices such that the higher the availability rate of rental cars, the lower the cost. Therefore, trip costs that are discounted relative to standard costs in regions with relatively low popularity may be reported to the user. Because the user may understand travel costs including car rental costs, the user may decide on a trip destination without concern about expenses required for transport at the trip destination.

In the present exemplary embodiment, the reporting section 58 reports discount rates applied to costs calculated from standard rates that do not take account of rental car availability rates. Therefore, the user may understand levels of discounts and may genuinely feel that discounts are being applied.

In the present exemplary embodiment, the trip cost calculation section 56 calculates costs with fuel costs of rental cars being included in the trip costs. Therefore, the user may use a rental car at the trip destination without worrying about fuel costs.

In the present exemplary embodiment, the reporting section 58 receives information relating to a travel routes in the vicinity of trip destinations, and the user may select a trip destination in accordance with their driving technique. For example, the reporting section 58 may report to the user that there are many narrow roads in a particular region, and a user with little experience of driving may exclude that region from the trip destinations.

In the present exemplary embodiment, the trip costs include facility usage fees. Therefore, the user may minimize costs to be paid at a trip destination, and the user may more easily understand a total amount required for the trip.

Above, the trip information reporting device 10 according to an exemplary embodiment and variant examples is described, but it will be clear that numerous embodiments are possible within a scope not departing from the gist of the present disclosure. For example, in the present exemplary embodiment the trip cost calculation section 56 sets the coefficient to 1 when the availability rate is 30%, and calculates a rental car cost to be the standard cost when the availability rate is 30% or less, but this is not limiting. Coefficients to be multiplied with the standard rate may be altered in steps for availability rates in ranges from 0% to 100%.

The trip cost calculation section 56 may predict a rental car availability rate for trip dates specified by the user and alter the coefficient in accordance with the predicted availability rate. For example, even if few car rentals have been booked for a peak season several months ahead, the trip cost calculation section 56 may anticipate future bookings and predict the availability rate, and may calculate the coefficient on the basis of the predicted availability rate.

In the exemplary embodiment described above, the trip cost calculation section 56 sets a lower car rental cost where a rental car availability rate is high, and calculates an amount in which trip costs beside the car rental cost are added, but this is not limiting. For example, the trip cost calculation section 56 may set a coefficient that is smaller where the rental car availability rate is higher, and may multiply trip costs including the car rental cost by this coefficient to calculate an overall trip cost. In this situation, a discount amount may be greater than in a situation in which the coefficient is multiplied only with the standard car rental cost to calculate the trip cost, and users may be encouraged to plan trips taking account of rental car availability rates.

In the exemplary embodiment described above, a car rental cost is multiplied by a certain coefficient regardless of car model, but this is not limiting. For example, respective availability rates of car models may be acquired and the trip cost calculation section 56 may calculate trip costs such that trip costs are lower for models with higher availability rates. In this situation, because car rental costs are discounted more for less popular models, more users may be encouraged to drive and variability in usage rates of rental cars may be reduced.

The processing that, in the exemplary embodiment described above, is executed by the CPU 20 reading a program may be executed by various kinds of processor other than a CPU. Examples of processors in these cases include a PLD (programmable logic device) in which a circuit configuration can be modified after fabrication, such as an FPGA (field programmable gate array) or the like, a dedicated electronic circuit which is a processor with a circuit configuration that is specially designed to execute specific processing, such as an ASIC (application-specific integrated circuit) or the like, and so forth. The trip information reporting processing may be executed by one of these various kinds of processors, and may be executed by a combination of two or more processors of the same or different kinds, for example, plural FPGAs, a combination of a CPU with an FPGA, or the like. Hardware structures of these various kinds of processors are, to be more specific, electronic circuits combining circuit components such as semiconductor components and the like.

The exemplary embodiment described above has a configuration in which various kinds of data are memorized in the storage 26, but this is not limiting. For example, a non-transitory recording medium, such as a CD-ROM (compact disc read-only memory), DVD-ROM (digital versatile disc read-only memory), USB (universal serial bus) memory or the like, may be used as a memory section. In this case, various programs, data and the like are stored at this recording medium.

What is claimed is:

1. A trip information reporting device, comprising a processor, the processor being configured to:
acquire a trip cost including a car rental cost from a plurality of regions, the car rental cost being established on the basis of information relating to rental car availability; and
report the trip costs from the plurality of regions to a user.

2. The trip information reporting device according to claim 1, wherein the car rental cost is established for respective car rental offices, such that the higher a rental car availability rate is, the lower the car rental cost is.

3. The trip information reporting device according to claim 1, wherein, together with the trip cost, the processor reports a discount amount or discount rate applied to a standard rate for car rental.

4. The trip information reporting device according to claim 1, wherein, as the trip cost, the processor reports to the user an amount including a fuel cost of a rental car.

5. The trip information reporting device according to claim 1, wherein the processor reports to the user information relating to a travel route in a vicinity of a trip destination.

6. The trip information reporting device according to claim 1, wherein, as the trip cost, the processor reports to the user an amount including an accommodation fee at a trip destination and a facility usage fee in a vicinity of the trip destination.

7. A trip information reporting method, comprising:
acquiring a trip cost including a car rental cost from a plurality of regions, the car rental cost being established on the basis of information relating to rental car availability; and
reporting the trip costs from the plurality of regions to a user.

8. A non-transitory storage medium storing a program executable by a computer to perform processing, the processing comprising:
acquiring a trip cost including a car rental cost from a plurality of regions, the car rental cost being established on the basis of information relating to rental car availability; and
reporting the trip costs from the plurality of regions to a user.
